(19) United States
(12) Patent Application Publication
(10) Pub. No.: US 2023/0157198 A1
(43) Pub. Date: May 25, 2023

(54) PROCESSES AND COMPOSITIONS FOR INCREASING ENZYME CONCENTRATIONS AND DRY MATTER USING REACTIVE OXYGEN SPECIES IN HYDROPONICALLY GROWN CELLULOSIC MATERIALS

(71) Applicant: HydroGreen, Inc., LANGLEY (CA)

(72) Inventor: Shawn Jenkins, Colton, SD (US)

(73) Assignee: HydroGreen, Inc., LANGLEY (CA)

(21) Appl. No.: 17/533,862

(22) Filed: Nov. 23, 2021

(51) Int. Cl. A01C 1/06

(52) U.S. Cl. CPC A01C 1/06

(57) ABSTRACT

An external reactive oxygen species application system and method for increasing enzyme activity and plant dry matter through the use of reactive oxygen species in hydroponically grown cellulosic materials. The external reactive oxygen species application system disinfects a plurality of seeds with the reactive oxygen species using a liquid applicator at a first concentration during a seed out phase. The reactive oxygen species increases gibberellic acid expression. The liquid applicator applies the reactive oxygen species at a second concentration during the plant development phase increase plant dry matter.

### FIELD OF THE INVENTION

The present disclosure relates to the use of reactive oxygen species to increase the enzyme activity and increase dry matter in hydroponically germinated seeds. Reactive oxygen species such as hydrogen peroxide have been used to promote the germination percentage of seedlings. More particularly, but not exclusively, the present invention relates to processes and compositions for increasing enzyme concentrations using reactive oxygen species in hydroponically grown cellulosic materials.

### BACKGROUND

Germination and seedling development in angiosperms is commonly regulated by two antagonist phytohormones, gibberellins and abscisic acid. The release of gibberellins supports the break of dormancy, cell division, and the release of hydrolytic enzymes whereas the release of abscisic acid maintains seed dormancy, inhibits the release of hydrolytic enzymes and reduced cellular division. The oxidative mode of action of gibberellins is mimicked in vivo when reactive oxygen species are introduced; supporting the release of hydrolytic enzymes from the aleurone layer and other plant cellular tissues. In addition, ligninolytic enzymes such as peroxidases favor delignification pathways when reactive oxygen species are present in contrast to lignification reactions when reactive oxygen species are absent. Delignification facilitated by ligninolytic enzyme hydrolysis supports improved fiber digestibility as lignin is generally regarded as the most complex and indigestible fiber complex in higher plants. Therefore, what is needed is the application of reactive oxygen species in hydroponic environments to increase dry matter and enzymatic activity.

### SUMMARY

Therefore, it is a primary object, feature, or advantage of the present disclosure to improve over the state of the art.

It is a further object, feature, or advantage of the present disclosure to increase the dry matter of hydroponically grown plants.

It is a still further object, feature, or advantage of the present disclosure to increase the enzyme activity of hydroponically grown plants.

Another object, feature, or advantage is to decrease abscisic acid activity by externally introducing reactive oxygen species (ROS) to a plant or seed.

Yet another object, feature, or advantage is to increase gibberellin activity by externally introducing ROS to a plant or seed.

One or more of these and/or other objects, features, or advantages of the present disclosure will become apparent from the specification and claims that follow. No single aspect need provide each and every object, feature, or advantage. Different aspects may have different objects, features, or advantages. Therefore, the present disclosure is not to be limited to or by any objects, features, or advantages stated herein.

In one aspect of the present disclosure, a method for external application of ROS to increase dry matter and enzyme activity is disclosed. The method may include disinfecting a plurality of seeds with at least one ROS, wherein the ROS is configured to kill at least one of harmful bacteria, mold, or fungi. The method may also include externally applying the at least one ROS to the plurality of seeds on a growing surface at a first concentration during a seed out phase, wherein the at least one ROS increases gibberellic acid expression. The method may a lso include germinating the plurality of seeds and externally applying the at least one ROS to the germinated plurality of seeds at a second concentration for a plant development phase until the germinated plurality of seeds mature.

In another aspect of the present disclosure, an external ROS application system is disclosed. The system may include a growing surface operably supported by a framework and disposed across a length and width of the framework. The growing surface may be configured to house a plurality of seeds. The system may also include a ROS source operably connected to the framework. The ROS source may house at least one ROS. The system may further include one or more liquid applicators operably secured to the framework adjacent the growing surface for discharging the at least one ROS from the ROS source onto the plurality of seeds housed on the growing surface. The one or more liquid applicators may discharge the at least one reactive oxygen species at different concentrations. The at least one reactive oxygen species promotes germination of the plurality of seeds on the growing surface.

In another aspect of the present disclosure, a method for increasing the dry matter of a plurality of plants by external application of ROS is disclosed. The method may include placing a plurality of seeds on a growing surface, wherein the growing surface may include a top surface for hydroponically growing the plurality of seeds atop of the growing surface. The method may further include introducing the at least one ROS by a liquid applicator on to the growing surface at a first concentration for a first time period. The method may further include disinfecting the plurality of seeds by a first ROS of a plurality of reactive oxygen species introduced by the liquid applicator and germinating the plurality of seeds on the growing surface. Lastly the method may include discharging a second reactive oxygen species of a plurality of reactive oxygen species by the liquid applicator at a second concentration for a second time period.

### BRIEF DESCRIPTION OF THE DRAWINGS

Illustrated embodiments of the disclosure are described in detail below with reference to the attached drawing figures, which are incorporated by reference herein.

FIG. 1 is an illustration of the ROS application system in accordance with an illustrative aspect of the disclosure.

FIG. 2 is a flowchart illustrating ROS interaction with plant hormones in accordance with an illustrative aspect of the disclosure.

FIG. 3 is an illustration of the interaction between phytohormones in accordance with an illustrative aspect of the disclosure.

FIG. 4 is an illustration of a chemical reaction between a lignin and an ROS in accordance with an illustrative aspect of the disclosure.

FIG. 5 is a chart illustrating the germination percentage of barley over different hydrogen peroxide concentrations and salinity treatments in accordance with an illustrative aspect of the disclosure.

FIG. 6 is an illustration of the interaction between phytohormones and dry matter in accordance with an illustrative aspect of the disclosure.

FIG. 7 is a perspective view of a seed cleaner of the ROS application system in accordance with an illustrative aspect of the disclosure.

FIG. 8 is a side perspective view of a portion of the holding container of the ROS application system in accordance with an illustrative aspect of the disclosure.

FIG. 9 is another side perspective view of a portion of the ROS application system illustrating an ROS irrigation system thereof.

FIG. 10 is a side perspective view of a portion of the hydroponic grower illustrating another ROS irrigation system thereof.

FIG. 11 is an end perspective view of a portion of the hydroponic grower further illustrating the ROS irrigation system shown in FIG. 10.

FIG. 12 is a side perspective view of a portion of the hydroponic grower illustrating another ROS irrigation system thereof.

FIG. 13 is a flowchart illustrating a method of ROS application by the ROS application system in accordance with an illustrative aspect of the disclosure.

FIG. 14 is another flowchart illustrating a method of ROS application by the ROS application system in accordance with an illustrative aspect of the disclosure.

FIG. 15 is another flowchart illustrating a method of ROS application by the ROS application system in accordance with an illustrative aspect of the disclosure.

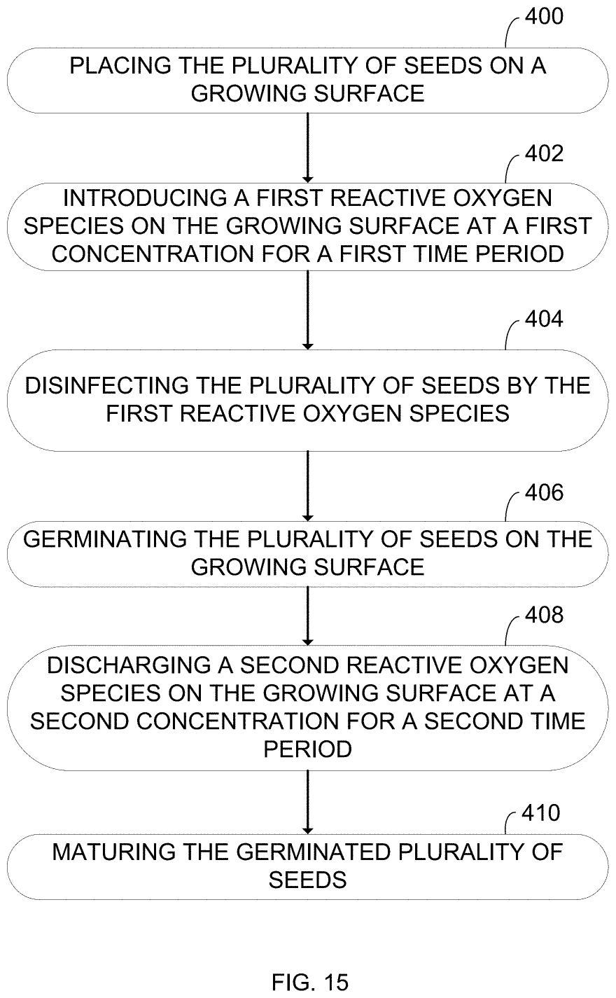

### DETAILED DESCRIPTION

In a hydroponic environment, seed can be grown hydroponically to full growth in roughly 5-7 days depending upon elevation, added nutrients, irrigation, lighting, etc. External application of ROS can influence the phytohormone balance within higher plants, favoring gibberellin synthesis. Through influencing the phytohormone balance during germination, enzymatic activity, stored nutrient mobilization, and dry matter accumulation is favorably increased.

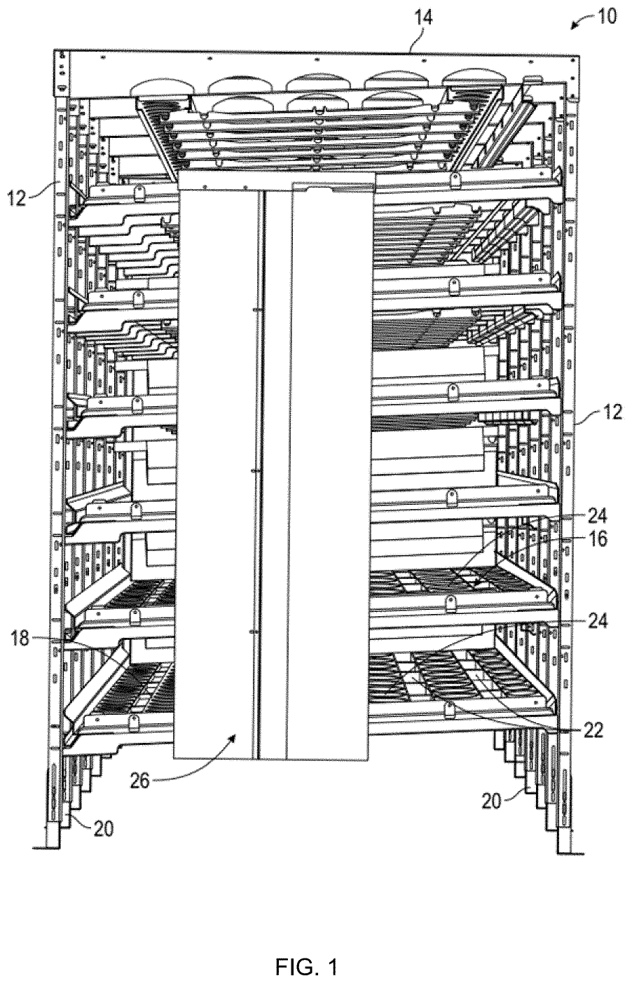

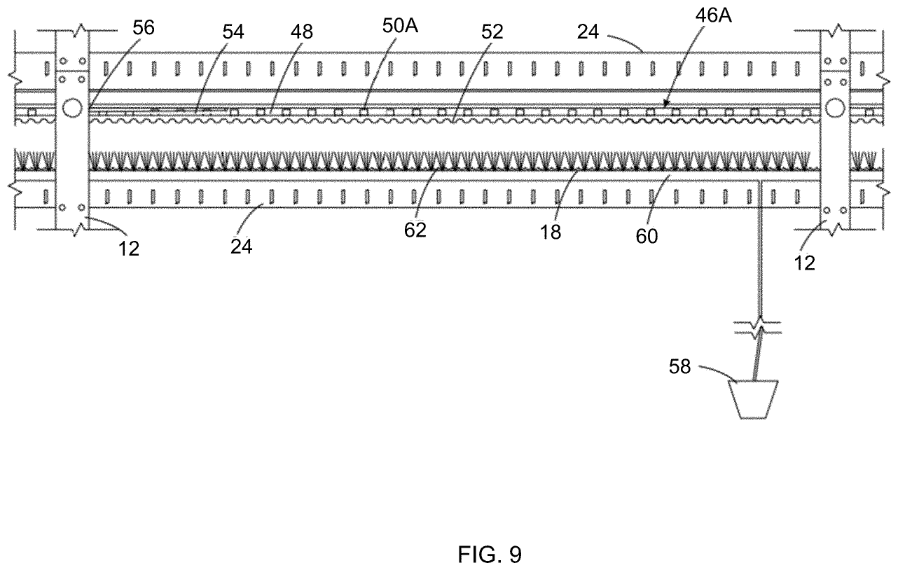

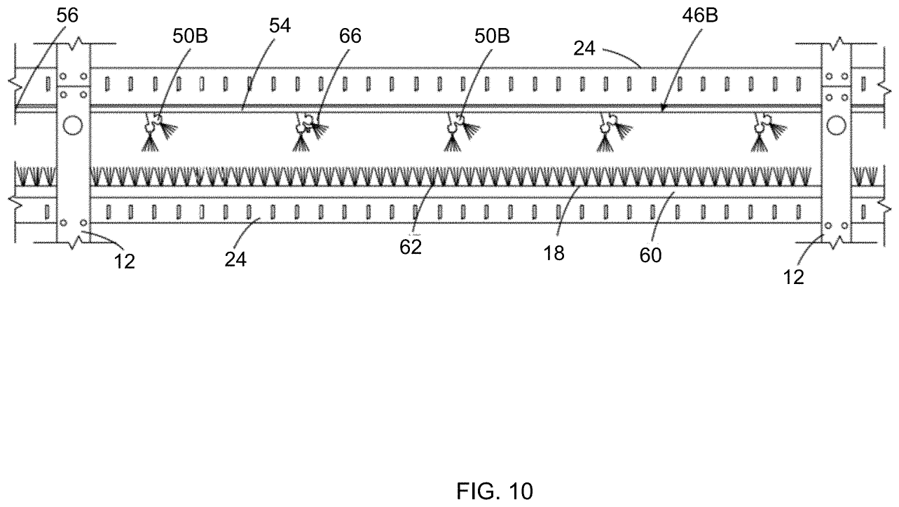

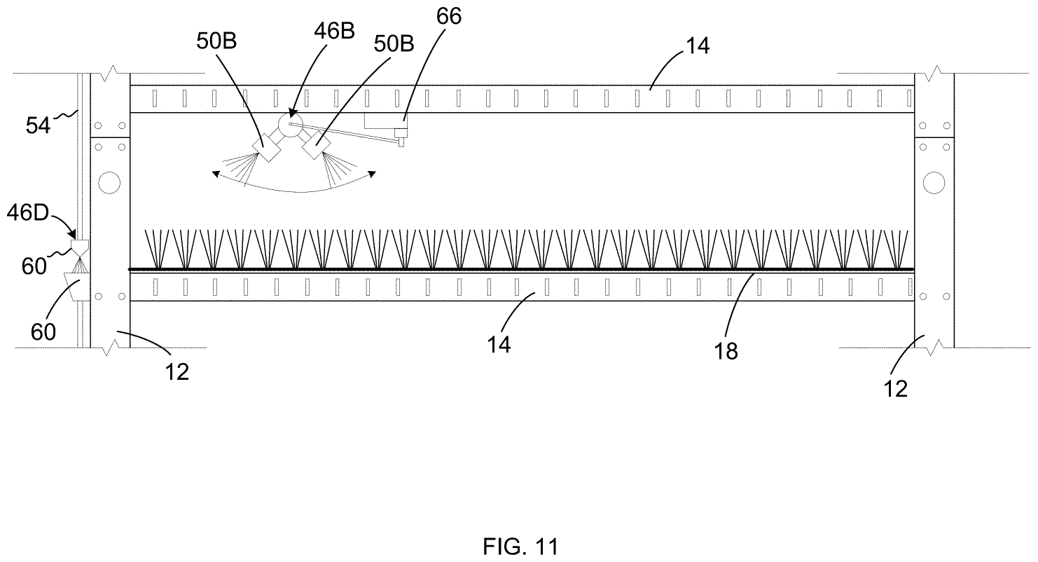

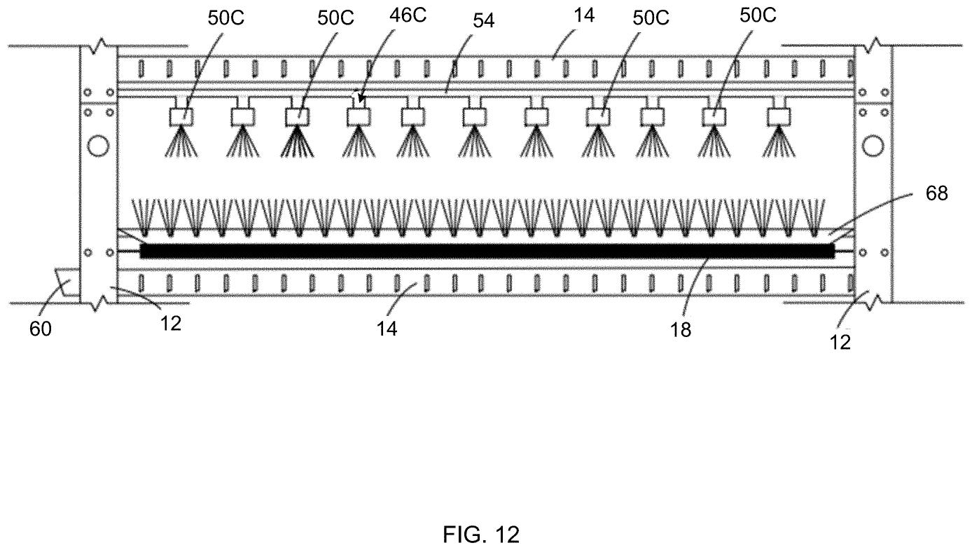

The external ROS application system 10, shown in FIGS. 1 and 8-12 may include of a plurality of vertical members 12 and a plurality of horizontal members 14 removably interconnected to form an upstanding seed growing table 16 with one or more holding containers 58. In some aspects of the present disclosure, the ROS application system 10 may have one or more seed growing tables and one or more holding containers 58. Each vertical member 12 may be configured to terminate at the bottom in an adjustable height foot 20. Each foot 20 may be adjusted to change the relative vertical position or height of one vertical member 12 relative to another vertical number 12 of the seed growing table 16. The horizontal member 14 may be configured to include one or more lateral members removably interconnected with one or more longitudinal members 24. A pair of vertical members 12 may be separated laterally by a lateral member 22 thereby defining the width or depth of the seed growing table 16. Longitudinal members 24 may be removably interconnected with lateral members 22 by one or more connectors 26. The ROS application system may be configured to apply at least one ROS to a plurality of seeds housed in the holding container 58.

Through the application of ROS in hydroponic environments, the oxidative mode of action of gibberellins is mimicked in vivo supporting the release of hydrolytic enzymes from the aleurone layer and other plant cellular tissues. In addition, ligninolytic enzyme such as peroxidases favor delignification pathways when ROS are present in contrast to lignification reactions when ROS are absent. Delignification facilitated by ligninolytic enzyme hydrolysis supports improved fiber digestibility as lignin is generally regarded as the most complex and indigestible fiber complex in higher plants. The external ROS increases the amount of dry matter of hydroponically grown cellulosic materials and maximizes enzyme activity. In higher plants, enzyme release during the germination process is commonly controlled by the release of gibberellic acid (GA) from the embryo. Prior to photosynthesis, the rate of GA released is positively correlated to the metabolic needs of the juvenile plants. Larger metabolic needs signal increased rates of the release of gibberellic acid. By using a system and method that provides external application of ROS to the plant or the seed, the hypoxic conditions are limited, and the efficiency of cellular respirations is maximized. The lignin peroxidase is energetically favored towards lignin deconstructive pathways rather than lignification.

The term “dry matter” refers to all the plant material excluding water. The nutrient or mineral content of animal feed or plant tissues may be expressed on a dry matter basis or the proportion of the total dry matter in the material. The plant or seed may refer to any plant from the kingdom Plantae or angiosperms including flowering plants, cereal grains, grain legumes, grasses, roots and tuber crops, vegetable crops, fruit plants, pulses, medicinal crops, aromatic crops, beverage plants, sugars and starches, spices, oil plants, fiber crops, latex crops, food crops, feed crops, plantation crops or forage crops.

Cereal grains may include rice (Oryza sativa), wheat (Triticum), maize (Zea mays), rye (Secale cereale), oat (Avena sativa), barley, (Hordeum vulgare), sorghum (Sorghum bicolor), pearl millet (Pennisetum glacucum), finger millet (Eleusine coracana), barnyard millet (Echinochloa frumentacea), italian millet (Setaria italica), kodo millet (Paspalum scrobiculatum), common millet (Panicum millaceum).

Pulses may include black gram, kalai, or urd (Vigna mungo var, radiatus), chickling vetch (Lathyrus sativus), chickpea (Cicer arietinum), cowpea (Vigna sinensis), green gram mung (Vigna radiatus), horse gram (Macrotyloma uniflorum), lentil (Lens esculenta), moth bean (Phaseolus aconitifolia), peas (Pisum sativum) pigeon pea (Cajanas cajan, Caj anus indicus), philipesara (Phaseolus trilobus), soybean (Glycine max).

Oilseeds may include black mustard (Brassica nigra), castor (Ricinus communis), coconut (Cocus nucifera), peanut (Arachis hypgaea), Indian mustard (Brassica juncea), toria (Napus), niger (Guizotia abyssinica), linseed (Linum usitatissumun), safflower (Carthamus tinctorious), sesame (Seasmum indicum), sunflower (Helianthus annus), white mustard (Brassica alba), oil palm (Elaeis guniensis). Fiber crops may include sun hemp (Crotalaria juncea), jute (Corchorus), cotton (Gossypium), mesta (Hibiscus), or tobacco (Nicotiana).

Sugar and starch crops may include potato (Solanum tberosum), sweet potato (Ipomea batatus), tapioca (Manihunt esculenta), sugarcane (Saccharum officinarum), sugar beet (Beta vulgaris). Spices may include black pepper (Piper nigrum) betel vine (Piper betle), cardamom (Elettaria cardamomum), garlic (Allium sativum), ginger (Zingiber officinale), onion (Allium cepa), red pepper or chillies (Capsicum annum), or turmeric (Curcuma longa). Forage grasses may include buffel grass or anjan (Cenchrus ciliaris), dallis grass (Paspalum dilatatum), dinanath grass (Pennisetum), guniea grass (Panicum maximum), marvel grass (Dicanthium annulatum), napier or elephant grass (Pennisetum purpureum), pangola grass (Digitaria decumbens), para grass (Brachiaria mutica), sudan grass (Sorghum sudanense), teosinte (Echlaena mexicana), or blue panicum (Panicum antidotale). Forage legume crops may include berseem or egyptian clover (Trifolium alexandrinum), centrosema (Centrosema pubescens), gaur or cluster bean (Cyamopsis tetragonoloba), Alfalfa or lucerne (Medicago sativa), sirato (Macroptlium atropurpureum), velvet bean (Mucuna cochinchinensis).

Plantation crops may include banana (Musa paradisiaca), areca palm (Areca catechu), arrowroot (Maranta arundinacea), cacao (Theobroma cacao), coconut (Cocos nucifera), Coffee (Coffea arabica), tea (Camellia theasinesis). Vegetable crops may include ash gourd (Beniacasa cerifera), bitter gourd (Momordica charantia), bottle gourd (Lagenaria leucantha), brinjal (Solanum melongena), broad bean (Vicia faba), cabbage (Brassica), carrot (Daucus carota), cauliflower (Brassica), colocasia (Colocasia esulenta), cucumber (Cucumis sativus), double bean (Phaseolus lunatus), elephant ear or edible arum (Colocasia antiquorum), elephant foot or yam (Amorphophallus campanulatus), french bean (Phaseolus vlugaris), knol khol (Brassica), yam (Dioscorealettuce (Lactuca sativa), muskmelon (Cucumis melo), pointed gourd or parwal (Trchosanthes diora), pumpkin (Cucrbita), radish (Raphanus sativus), bhendi (Abelmoschus esculentus), ridge gourd (Luffa acutangular), spinach (Spinacia oleracea), snake gourd (Trichosanthes anguina), tomato (Lycoperscium esculentus), turnip (Brassica), orwatermelon (Citrullus vulgaris).

Medicinal crops may include aloe (Aloe vera), ashwagnatha (Withania somnifera), belladonna (Atropa belladonna), bishop's weed (Ammi visnaga), bringaraj (Eclipta alba.), cinchona (Cinchona sp.) coleus (Coleus forskholli), dioscorea, (Dioscorea), glory lily (Gloriosa superba), ipecae (Cephaelis ipecauanha), long pepper (Poper longum), prim rose (Oenothera lamarekiana), roselle (Hibiscus sabdariffa), sarpagandha (Rauvalfia serpentine) senna (Cassia angustifolia), sweet flag (Acorns calamus), or valeriana (Valeriana wallaichii).

Aromatic crops may include ambrette (Abelmoschus moschatus), celery (Apium graveolens), citronella (Cymbopogon winterianus), geranium (Pelargonium graveolens.), Jasmine (Jasminum grantiflorum), khus (Vetiveria zizanoids), lavender (Lavendula sp.) lemon grass (Cymbopogon flexuosus), mint, palmarosa (cymbopogon martini), patchouli (Pogostemon cablin), sandal wood (Santalum album), sacred basil (Ocimum sanctum), or Tuberose (Polianthus tuberosa). Food crops are harvested for human consumption and feed crops are harvested for livestock consumption. Forage crops may include crops that animals feed on directly or that may be cut and fed to livestock.

ROS are a type of unstable molecule that contains oxygen that can easily react with other molecules, such as a seed's coat, pathogens, or molecules within the cell. ROS can be formed due to the electron receptivity of O₂. ROS have important roles in functions such as important signaling molecules that regulate normal plant growth, and responses to stress. ROS are involved in photoprotection and a plant or seed's tolerance to different types of stress. However, too much ROS can cause damage to DNA, RNA, or other molecules as they oxidize, in some cases preventing cellular functions. Oxygen toxicity can arise both from uncontrolled production and form the inefficient elimination of ROS by antioxidants. During times of environmental stress such as UV exposure, heat exposure, drought, salinity, chilling, defense from pathogens, nutrient deficiency or other types of environmental stressors ROS levels can naturally increase. ROS can include hydrogen peroxide (H₂O₂), hydroxyl radicals (OH), hypochlorous acid (HOCL), nitric acid (NO), peroxyl radical, including both alkylperoxyl and hydroperoxyl (ROO, R may be an H), peroxynitrite anion (ONOO⁻), oxygen (O₂), superoxide anion (O₂), peroxide (O₂⁻²). H₂O₂ is moderately reactive and has a relatively long half-life allowing it to diffuse some distances from the original release site or site of production.

Internal ROS production in plants is mainly found in the chloroplast, mitochondria and peroxisomes, but can also be found in the endoplasmic reticulum, cell membrane, cell wall and apoplast. The chloroplast photosystems, PSI and PSII, are major sources of internal ROS production. Abiotic stress factors lead to the formation of ROS through the Mehler reaction or the Fenton reaction and subsequently convert the O^{•-}₂ into H₂O₂. In the mitochondria, ROS are produced during normal conditions, but production is greatly increased by abiotic stress conditions. Peroxisomes are major sites of ROS production due to their oxidative metabolism. During stressful conditions, when the availability of water is low and stomata remains closed, increased photorespiration leads to glycolate formation. The glycolate is oxidized by glycolate oxidase in peroxisome to release H₂O₂, making it the leading producer of H₂O₂ during photorespiration. At times of adverse environmental conditions, stress signals combined with abscisic acid (ABA) make the apoplast a prominent site for H₂O₂ production inducing stomatal closure. The cell membrane provides information necessary for the survival of the plant cell. The electron transport system of the endoplasmic reticulum generates local ROS.

External ROS are ROS that are not internally produced by the plant or seed. External ROS can be externally applied to the plant or the seed of the plant by an applicator or introduced through a plant growing surface or soil. The external ROS can include a single type of ROS, such as H₂O₂, or a plurality of types of ROS, such as H₂O₂ and O₂⁻².

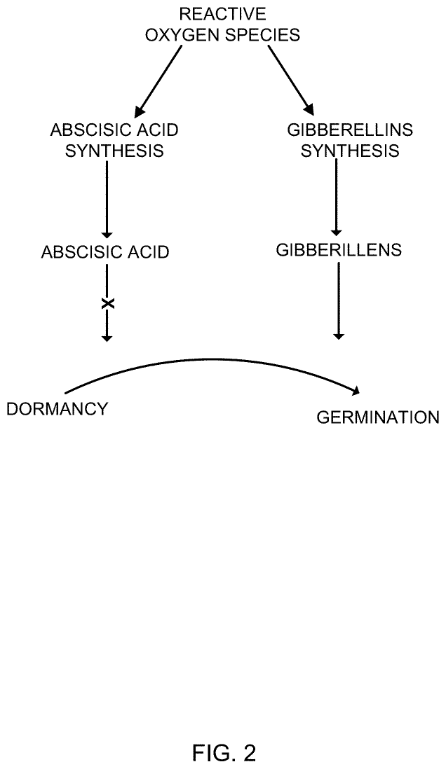

The accumulation of internal and external ROS within a plant, seed, or a cell leads to a variety of cellular responses. Plant responses may be ROS dose dependent. ROS allow for vital hormone balance. ROS can act as plant signalers, can cross bio membranes, and may inactivate or activate enzymes. Therefore, a controlled amount of ROS introduced to the plant may be necessary. ROS may oxidize ABA making ABA inactive. ROS may do so by activating GA, as shown in FIG. 2.

ROS may interact with the outside chemistry of the seed or cell wall. Some seeds have a waxy outer coating which may contain chemicals or physical barriers that prevent germination or prevent water from entering the seed. Seeds with a waxy outer layer may include cereal grains such as wheat, barley, and rye. In some aspects, the O₂ component of the ROS reacts with the cell wall or outer layer of the seed coat causing the cell wall or waxy outer layer to weaken, loosen or bubble thereby softening the cell wall. The ROS may even break the seed coat or cell wall open. ROS can also break down a cell wall by mediating poly saccharide deterioration and activating calcium channels and mitogen-activated protein kinases, enlarging and loosening the cell wall and causing weak points in the cell wall. External ROS can be introduced into a seed's environment to create weak spots in the seed coat allowing water to enter the seed more quickly. This may help the seed begin germinating. The creation of weak spots by the external ROS causes the seed to release additional internal ROS within the seed which interact with the interior of the cell wall or seed coat further weakening the wall. In the absence of ROS, the cell wall is strengthened and dormancy may continue.

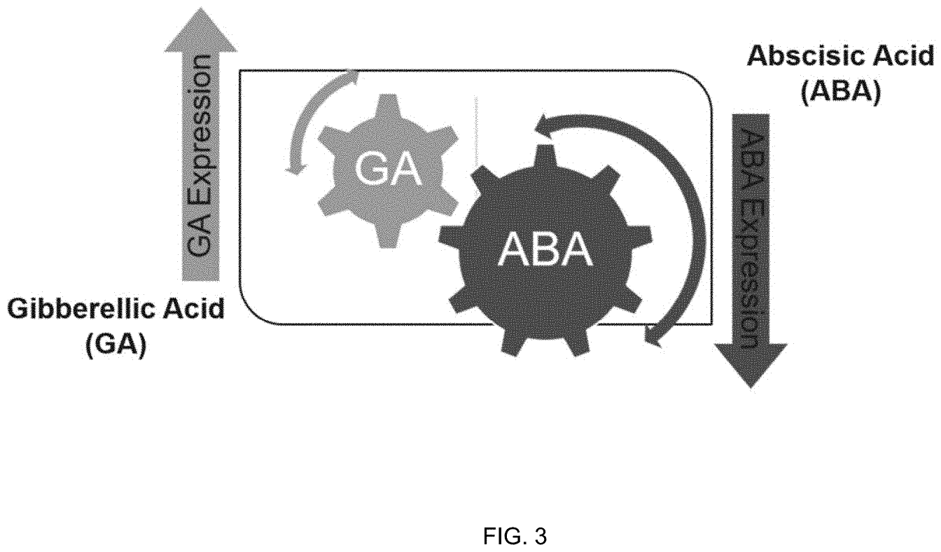

The external introduction of ROS can jumpstart a seed's germination and end dormancy. ROS action during seed germination, as shown in FIG. 2, is based on interactions between phytohormones that regulated seed dormancy or seed germination such as ABA, GA, and ethylene (ET). ABA inhibits ROS-mediated effects on seed germination by the promotion of ROS scavenging enzyme activity. The ratio of ABA and GA regulates seed dormancy, as shown in FIG. 3. High ABA/GA ratios favor dormancy, whereas low ABA/GA ratios result in seed germination. High ABA/GA ratios can be counteracted by the controlled introduction of additional external ROS into the soil or growing surface or directly onto the seed or plant. The ROS are absorbed by the seed or plant. GA can also counteract the ROS-scavenging enzymes by downregulating the enzymes. The ROS can also oxidize ABA as well, decreasing the amount of ABA to GA. In some cases, ROS can release seed dormancy by activating GA signaling and synthesis rather than the repression of ABA signaling or ABA catabolism. GA synthesis can induce additional ROS production in seeds. ROS then subsequently acts as a signal molecule to antagonize ABA signaling. External ROS can increase internal ROS content of a seed synthesizing or activating additional GA or repression of more ABA signals. The external application of ROS decreases ABA levels and increases GA concentrations, which triggers seed germination. However, the amount or concentration of ROS may need to be monitored. Above certain limits, ROS are either too low to allow germination or too high and affect embryo viability and therefore prevent or delay germination. This creates an ‘oxidative window’ for germination that restricts proficient seedling development within certain borders of increased ROS levels.

During germination, GA translocates to the aleurone layer. α-amylase synthesis is triggered when GA interacts with the aleurone layer of the seed, thereby releasing or synthesizing hydrolytic enzymes, included α-amylase. The aleurone is located at the periphery of the starchy endosperm. The hydrolytic enzymes, such as 1,3; 1,4-β-glucanase (β-glucanase), α-amylase and β-amylase, are released to catalyse the breakdown of cell wall polysaccharides, proteases, storage proteins, and starchy energy reserves that are essential for germination, providing sugars that drive the root growth. β-glucanase may hydrolyse 1,3;1,4-β-glucan, a predominant cell wall polysaccharide. The α-amylase cleaves internal amylose and amylopectin residues. The β-amylase exo-hydrolase liberates maltose and glucose from the starch molecules. Without the repression of ABA by the introduction of external ROS, the ABA inhibits the transcription of hydrolytic enzymes, preventing germination.

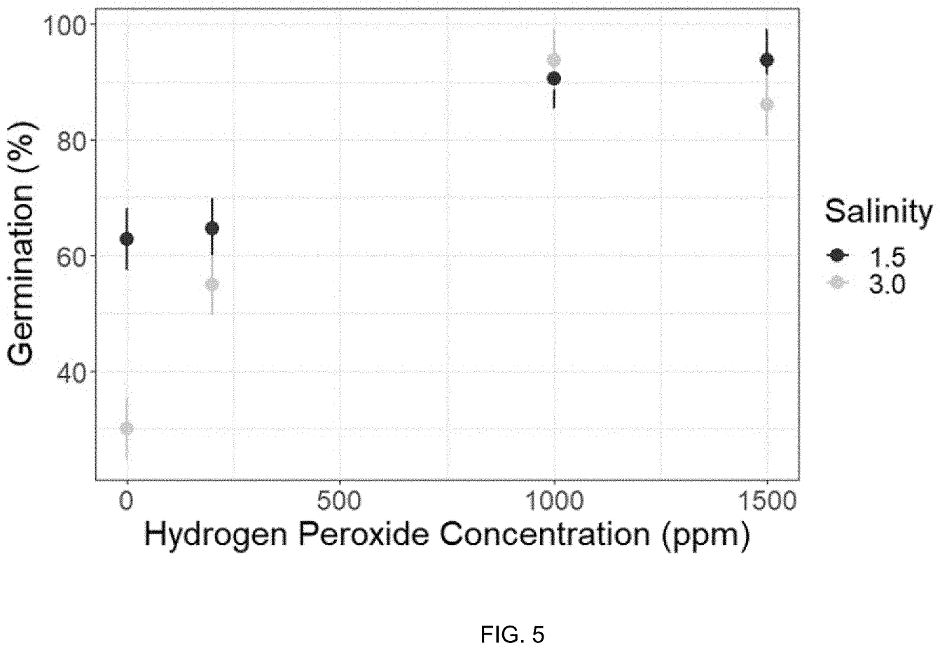

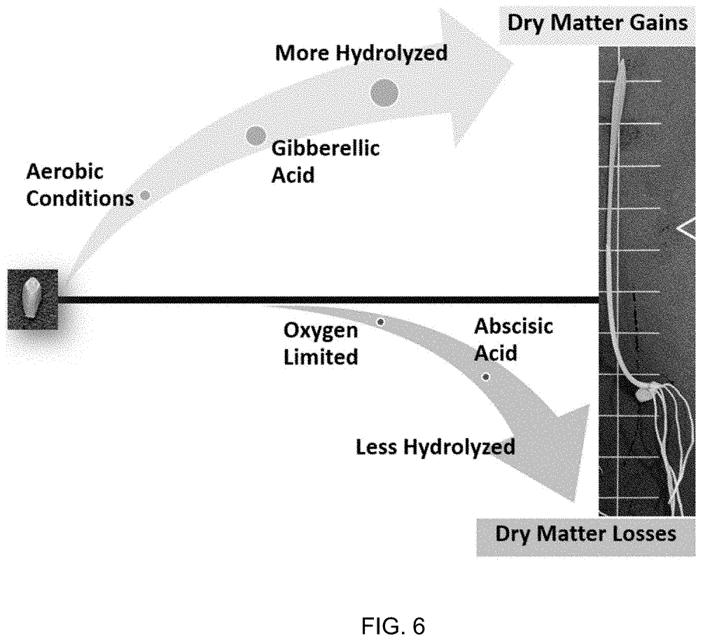

In hydrated seeds under aerobic conditions, ROS production and external ROS application correlates to increased metabolism in chloroplasts, mitochondria, glyoxysomes, peroxisomes, and the plasma membrane. During seed imbibition, compartmentalization of ROS in different subcellular structures and their target molecule regulates the expression of various genes. Water allows ROS to be transported or to travel over greater distances whereas in dry seeds ROS production must be near targets during seed imbibition. When a seed or plant is hydrated, external ROS may easily translocate from outside the cell, seed, or plant to the interior of the cell, seed, or plant increasing enzyme activity and dry matter, as shown in FIG. 6. FIG. 5 illustrates the germination percentage of barley over differing H₂O₂ concentrations and salinity treatments. Salinity treatment expressed as salinity concentration in parts per thousand. The values shown in FIG. 5 are expressed in a fixed effect linear model estimation with 95 percent confidence interval illustrating the surrounding estimate. Through the application of ROS, the inhibitory influence of ABA included reduced stem elongation and germination is reduced.

During stress, the cell wall-localized lipoxygenase causes hydroperoxidation of polyunsaturated fatty acids (PUFA) making it an active source of ROS. During a pathogen attack, lignin precursors undergo extensive cross-linking, via ROS-mediated pathways to reinforce the cell wall with lignin. Lignin fills the spaces in the cell wall between cellulose material, hemicellulose, and pectin components, especially in vascular and support tissues: xylem tracheids, vessel elements and sclereid cells. If external ROS are applied to the seed or plant, the external ROS may disinfect the seed or plant or kill some or all of the pathogens. This stops lignin precursors from cross-linking and strengthen the cell wall preventing germination or the growth of the plant.

The term “cellulosic material” means any material containing cellulose. The predominant polysaccharide in the primary cell wall of biomass is cellulose, the second most abundant is hemicellulose, and the third is pectin. The secondary cell wall, produced after the cell has stopped growing, also contains polysaccharides and is strengthened by polymeric lignin covalently cross-linked to hemicellulose. Cellulose is a homopolymer of anhydrocellobiose and thus a linear beta-(1-4)-D-glucan, while hemicelluloses include a variety of compounds, such as Xylans, Xyloglucans, arabinoxylans, and mannans in complex branched structures with a spectrum of Substituents. Although generally polymorphous, cellulose is found in plant tissue primarily as an insoluble crystalline matrix of parallel glucan chains. Hemicelluloses usually hydrogen bond to cellulose, as well as to other hemicelluloses, which help stabilize the cell wall matrix.

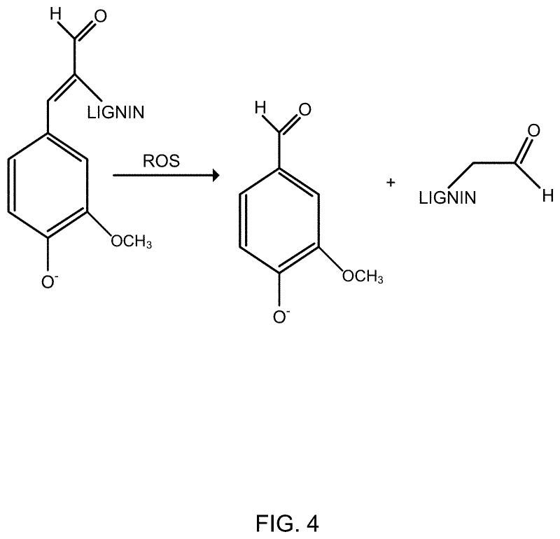

Lignin depolymerization can be achieved primarily by one-electron oxidation reactions catalyzed by extracellular oxidases and peroxidases in the presence of extracellular ROS or external ROS, as shown in FIG. 4. Hydroxyl radicals attack the lignin structures, creating access points for hydrolysis by whole cells, enzymes, or other chemicals. External application of ROS allows additional ROS to attack the lignin structures, creating additional access points for hydrolysis lignin, cellulose and hemicellulose by ligninolytic enzymes, hemicellulolytic enzymes or hemicellulose, cellulolytic enzymes or cellulase, and endoglucanase.

Ligninolytic enzymes are an enzyme that hydrolyzes the structure of lignin polymers. Enzymes that can break down lignin include lignin peroxidases, manganese peroxidases, laccases and feruloyl esterases, and other enzymes described in the art known to depolymerize or otherwise break lignin polymers. Also included are enzymes capable of hydrolyzing bonds formed between hemicellulose sugars (notably arabinose) and lignin. Hemicellulolytic enzymes or hemicellulase are one or more enzymes that hydrolyze a hemicellulose material. Endoglucanases are an endo-1,4-(1,3:1,4}-beta-D-glucan 4-glucanohydrolase (E.C. 3.2.1.4) that catalyzes endohydrolysis of 1,4-beta-Dglycosidic linkages in cellulose, cellulose derivatives (such as carboxymethyl cellulose and hydroxyethyl cellulose), lichenin, beta-1,4 bonds in mixed beta-1,3 glucans such as cereal beta-D-glucans or Xyloglucans, and other plant material containing cellulosic components. Cellulolytic enzymes or cellulase are means one or more enzymes that hydrolyze a cellulosic material. Such enzymes include endoglucanases, cellobiohydrolases, beta-glucosidases, or combinations thereof.

The ROS may oxidize the pericarp of a plant ovary. The pericarp is the ripened and variously modified walls of a plant ovary. The pericarp has an outer exocarp, a central mesocarp, and an inner endocarp, and this is the wall of a plant fruit that develops from the ovary wall. External ROS may trigger redox signaling during plant organ development including fruit ripening and flower development. Oxidative stress, the imbalance between ROS production and ROS elimination, occurs in the mitochondria due to increased respiratory rates during ripening affecting the redox state once sugars become a limiting factor and onset ripening. External ROS can increase the imbalance allowing the plant to ripen. Oxidative stress also occurs in the plastid during the chloroplast to chromoplast transition at the onset of fruit ripening.

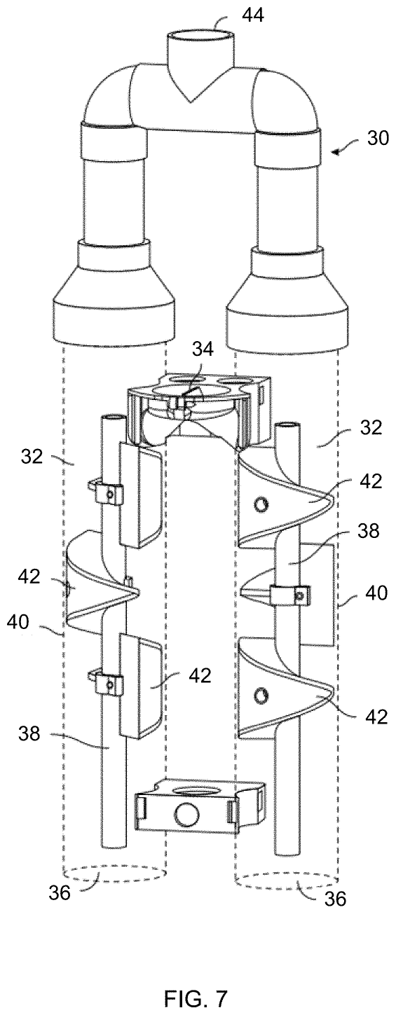

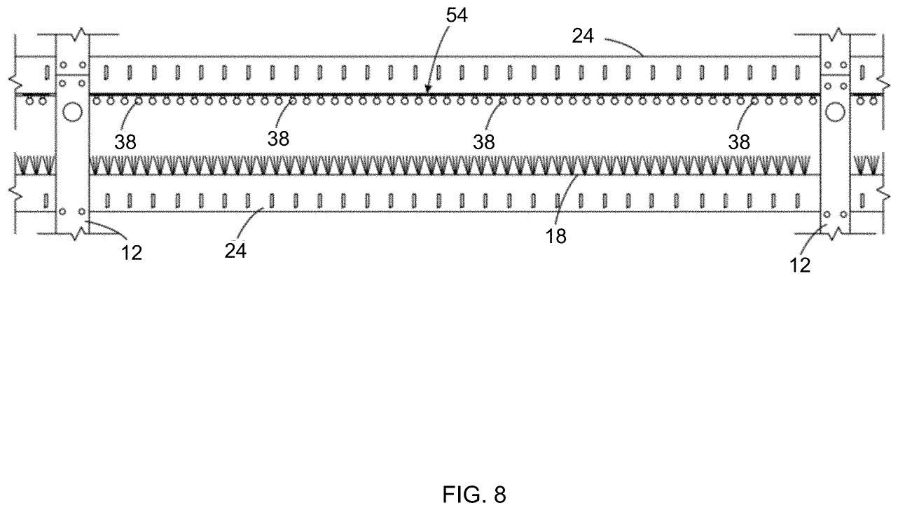

At the beginning of the seed out phase, ROS can be introduced to the seed's environment to disinfect the seed, the growing material the seed will be planted in, and the growing surface 18 for housing the growing material, such as a seed belt, a hydroponic grower, or a pan system, as shown in FIGS. 8-12. The growing surface 18 may include a top surface for hydroponically growing the plurality of seeds atop of the growing surface. The ROS kills harmful bacteria, mold or fungi growing on the seed, the growing material or the growing surface while preventing good bacteria present in the seed from being destroyed during the disinfection process. By killing the harmful bacterial, mold, or fungi using the ROS, beneficial or helpful bacteria can grow in the growth material or on the seed. The material of the growing surface 18 may be designed to help maintain an oxidative environment. For example, the bottom or sides of the growing surface 18 may be hydrophobic, permeable, or semipermeable. In some aspects of the present disclosure, the growing surface 18 may be disinfected by the ROS prior to the seed out phase. The seeds may also be cleaned or exposed to the ROS to be disinfected in a seed cleaner 30, as shown in FIG. 7, prior to entering the growing surface or as they enter the growing surface.

Often raw or bulk seed contains debris and other contaminants, and seed cleaner 30 may remove debris and contaminants from seed before conveying seed to the growing surface 18 or the framework 12. Seed cleaner 30 may include a separator housing 32 having a seed inlet 34, seed discharge 36, and disposed between seed inlet 34 and seed discharge 36, and may include one or more augers 38 disposed vertically within conduit 40 having a diameter of the flighting 42. Flighting 42 may be preferably non-continuous thereby leaving gaps between intermittently spaced sections of fighting for seed, debris, and contaminants to freefall from one level of fighting onto the next level of fighting. A vacuum line 44 may be operably connected at or near seed inlet 34 and connected at an opposing end to a vacuum source. Seed may be introduced into seed cleaner 30 through seed inlet 34 and descend fighting 42 and freefall between gaps in flighting 42 on each auger 38. Debris and contaminants may be sucked into vacuum line 44 and the seed may descend through seed discharge free of the debris and contaminants that are suctioned off into a refuse container. The cleaned seed may exit seed discharge 36 and be conveyed or placed on the growing surface 18. In some instances, seed may include larger debris that cannot be suctioned off without suctioning off seed too. A screen (not shown) can be operably disposed at the exit of seed discharge 36 to screen off larger debris that is not suctioned off while passing through seed cleaner 30. One or more plumbing elements may be operably configured to disinfect seed within a seed cleaner with a ROS applicator. One or more UV lighting elements can be operably configured to irradiate seed within seed cleaner 30 with UV light to kill bacteria on seed. The process of cleaning seed with seed cleaner 30, irradiating seed with UV light, and the general operation of seed cleaner 30, can be automated by a controller, graphical user interface, and/or remote control.

Each growing surface 18 may include a liquid applicator 46A, 46B, and/or 46C operably configured atop each growing surface 18 for irrigating seed disposed atop each growing surface 18. The dimensions of the growing surface 18 may be configured to accommodate need, desired plant output, or ROS application coverage. Liquid applicator 46A may be configured adjacent at least one longitudinal edge of growing surface 18. Liquid applicator 46A may also be operably configured adjacent at least one lateral edge of growing surface 18. Preferably, liquid applicator 46A may be configured adjacent a longitudinal edge of growing surface 18 to thereby provide drip-flood irrigation to growing surface 18 and seed disposed atop growing surface 18. Liquid applicator 46A may include a ROS guide 48 and ROS distributor 50A, 50B, 50C with a ROS egress 52 having a generally undulated profile, such as a sawtooth or wavy profile generally providing peak (higher elevated) and valley (lower elevated) portions. Liquid applicator 46A can include a ROS line 54 configured to carry ROS from a ROS source 56, such as a ROS collector 58 or plumbed ROS source 56. ROS may exit ROS line 54 through one or more openings and may be captured upon exiting ROS line 54 by ROS guide 48 and ROS distributor 50A. The one or more openings in ROS line 54 can be configured as ROS drippers, intermittently dripping a known or quantifiable amount of ROS over a set timeframe into ROS guide 48. The one or more openings may be configured intermittently along a length of ROS line 54 or dispersed in groupings along a length of ROS line 54. The one or more openings in ROS line 54 can be operably configured to equally distribute the ROS down the growing surface 18 and slowly drip liquid into the growing surface 18. Drip or flood irrigating the growing surface provides a layer of ROS 62 for soaking the seed and can provide liquid to seed on growing surface 18 in a controlled, even distributive flow. ROS distributor 50A can be configured with a ROS guide 48 adapted to collect liquid as it exits ROS line 54. Collected ROS may be evenly distributed by ROS distributor 50A and exit the ROS distributor 50A onto the growing surface 18 via the ROS egress 52.

According to at least one aspect, ROS egressing from ROS distributor 50A may travel atop growing surface 18 beneath and/or between a seed mass atop growing surface 18. Other configurations of liquid applicator 46 are also contemplated herein. For example, in one aspect, ROS may enter liquid applicator 46 through a ROS line 54 and exit ROS line 54 through a plurality of openings. ROS from ROS line 54 may coalesce into a small reservoir creating a balanced distribution of liquid across a length of ROS distributor 50A. When this small reservoir becomes full the ROS may run over and out of ROS egress 52, such as between the teeth of ROS egress 52. In this manner, ROS may be equally distributed down an entire length and across an entire width of the growing surface. From ROS egress 52, ROS may drip onto a growing surface 18 where it may run under a bulk of seed on the growing surface 18 to soak or make contact with the seed. The root system of seed on growing surface 18, along with a wicking effect, may move the ROS up through the seed to water all the seeds and/or plants.

Liquid applicator 46B may be disposed atop each growing surface 18. Liquid applicator 46B may include a plurality of ROS distributors 50B operably configured in a ROS line 54 operably plumbed to a ROS source 56. ROS distributor 50B can include spray heads, such as single or dual-band spray heads/tips, for spray irrigating seed disposed atop each growing surface 18. In one aspect, a plurality of ROS lines 54 may be disposed in a spaced arrangement atop each growing surface 18. Each ROS line 54 may traverse the length of the holding container and may be plumbed into connection with ROS source 56. Other ROS lines 54 can be configured to traverse the width of growing surface 18. ROS may be discharged from each ROS distributor 50B for spray irrigating seed atop each growing surface 18. In another aspect, each ROS line 54 may be oscillated back and forth over a 10°, 15°, 20°, 25°, 30°, 35°, 40°, 45°, or greater radius of travel for covering the entire surface area of the seed atop each growing surface 18. In the case where dual angle spray heads are used for ROS distributor 50B, the oscillation travel of each ROS line 54 can be reduced thereby reducing friction and wear and tear on liquid applicator 46B. The process of applying ROS to the seed or plant can be automated by a controller, graphical user interface, and/or remote control. A drive mechanism 66 can be operably connected to each ROS line 54 for oscillating or rotating each line through a radius of travel. Liquid applicator 46 can be operated manually or automatically using one or more controllers operated by a control system.

Liquid applicator 46 may be configured to clean growing surface 18 of debris, contaminants, mold, fungi, bacteria, and other foreign/unwanted materials. Liquid applicator 46 can also be used to irrigate seed with a disinfectant or ROS as seed is released onto growing surface 18 from a seed dispenser. A time delay can be used to allow the ROS to remain on seed for a desired time before applying or irrigating with fresh water. The process of cleaning, descaling, and disinfecting growing surface 18 using liquid applicator 46D can be automated by a controller, graphical user interface, and/or remote control.

Liquid applicator 46 can be operated immediately after seeding of the growing surface 18 to saturate seed with ROS. Seed in early, mid, and late stages of growth can be irrigated with ROS using liquid applicator 46. Liquid applicators 46A-D can be operated simultaneously, intermittently, alternately, and independent of each other. During early stages of seed growth, both liquid applicators 46A-B are operated to best saturate seed to promote sprouting and germination. During later stages of growth, liquid applicator 46A can be used to irrigate more than liquid applicator 46B. Alternatively, liquid applicator 46B can be used to irrigate more than liquid applicator 46A, depending upon saturation level of seed growth. Liquid applicator 46C can be operated during seeding of growing surface 18 and movement of growing surface 18 in the second direction to spray seed dispensed atop growing surface 18 to saturate seed with ROS. ROS provided to liquid applicators 46A-D could include additives, such as disinfectants and/or nutrients. Nutrients, such as commonly known plant nutrients, can be added to ROS dispensed from liquid applicators 46A-D to promote growth of healthy plants and/or increase the presence of desired nutrients in harvested seed. Liquid applicators 46C-D can be used also to sanitize growing surface 18 before and/or after winding on or unwinding of the seed belt, the growing surface 18, or atop of the growing surface 68.

Liquid distributors 46A-D and their various components, along with other components of external ROS application system 10, can be sanitized by including one or more disinfectants, such as ROS used by each ROS distributor 50A-D. For example, ROS guide 48, ROS lines 54, ROS egress 52, drain trough 60, ROS collector 58, growing surface 18, ROS distributors 50A-C, and other components of the growing system. In another aspect, liquid applicators 46A-D can be used to clean and sanitize growing surface 18 before, between, or after seeding and harvesting. A separate liquid distributor or manifold can be configured to disinfect or sanitize any components of the growing system that carry ROS for irrigation and cutting or receive irrigation or cutting runoff from the one or more holding containers.

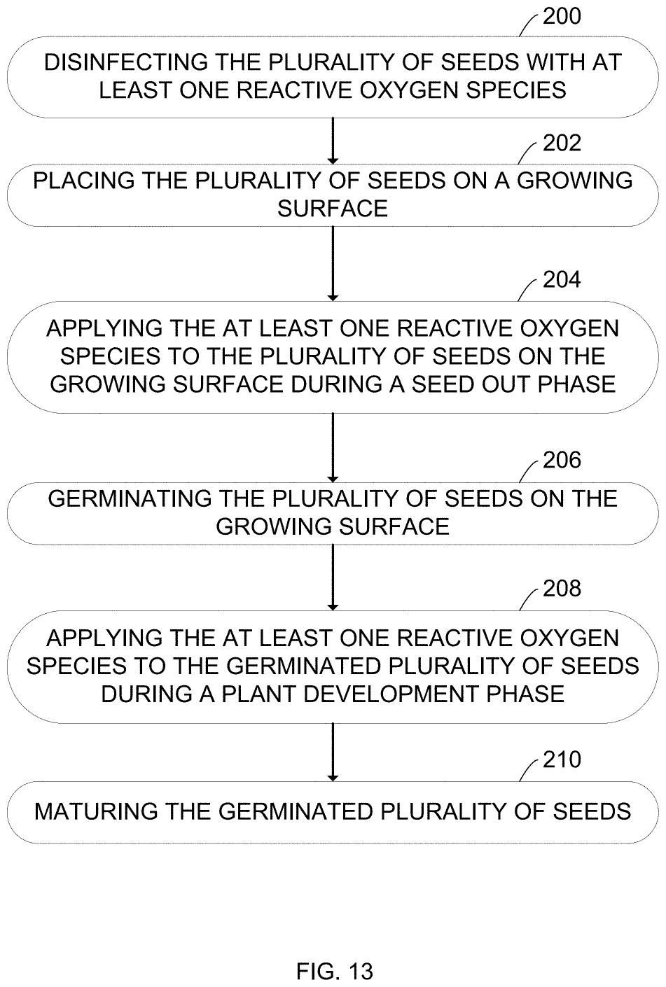

In one aspect of the application of ROS, as shown in FIG. 13, the ROS may be applied to disinfect the plurality of seeds (Step 200). Next, the plurality of seeds may be placed on a growing surface (Step 202) during a seed out phase. In some aspects of the present disclosure, the seeds may be disinfected after being placed on the growing surface. Next, at least one ROS may be applied to the plurality of seeds on the growing surface (Step 204) during the seed out phase. The external ROS may be constantly applied, or the applicator may apply the ROS at a set time frame or at a quantifiable amount. For example, the liquid applicator may apply the ROS for a first time period such as 1 minute and then the liquid applicator may stop applying the ROS for a second time period, such as 4 minutes, or 1 min of ROS application for every 5 minutes. Next the plurality of seeds may germinate (Step 206). Next, the ROS may be applied to the germinated plurality of seeds during a plant development phase (Step 208). Lastly, the germinated plurality of seeds may mature (Step 210). The ROS can be applied at a specific concentration during both seed out and plant development phases.

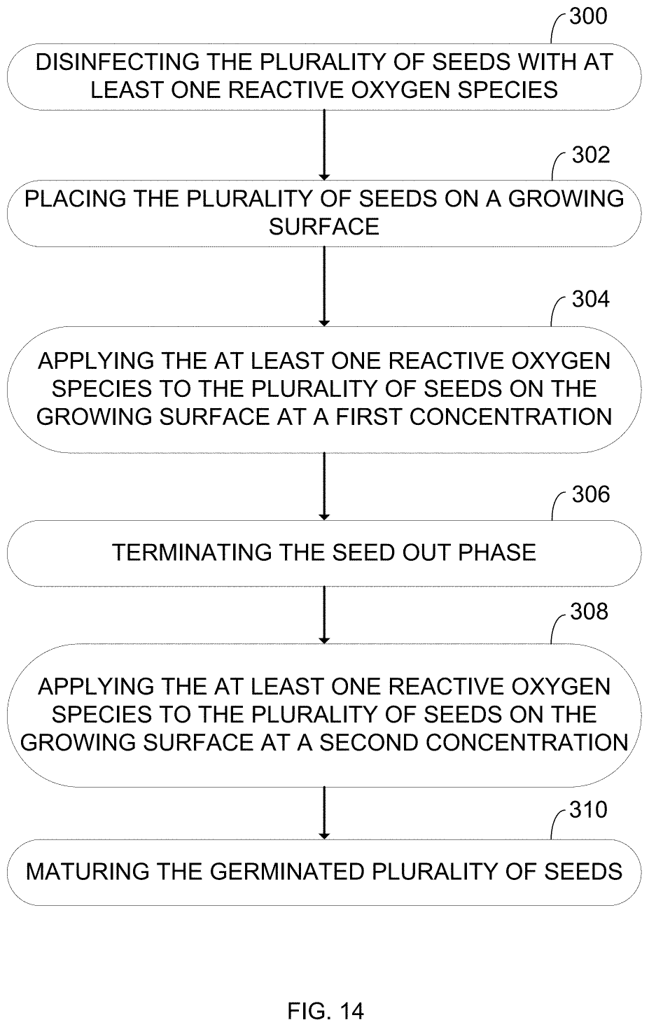

In another aspect of the application of ROS, as shown in FIG. 14, the ROS may be applied to disinfect the plurality of seeds (Step 300). Next, the plurality of seeds may be placed on a growing surface (Step 302) during a seed out phase. In some aspects of the present disclosure, the seeds may be disinfected after being placed on the growing surface. At seed out the ROS can be applied at a first concentration, such as a concentration ranging from 1000-3000 ppm (Step 304). Next the seed out phase may terminate (Step 306). The seed out phase may last 18 to 24 hours. However, the seed out phase may be shorter or longer than 18 to 24 hours. Moisture levels during seed out may range from 10-60 percent, however the moisture levels may be higher or lower. After the seed out phase terminates, ROS may be applied at a second concentration rate, such as 50-200 ppm, throughout plant development until the plant matures (Step 308). A higher rate during the seed out phase may promote the inactivation of biological contaminants present on the seed coat including bacterial contamination and fungal spores, pericarp oxidation, and initial hydrogen peroxide uptake. The higher rate of ROS application creates weak spots in the seed coat allowing the seed to increase water intake, and the intake of the external ROS by the seed increases the production of GA and decreases the amount of ABA or ABA signaling. The decrease in environmental stress of the seed and the increase in GA allow the seed to start germination. Lastly the seed or plurality of seed may mature and be ready to be harvested (Step 310).

After the initiation of metabolic activity, a lower rate may be needed. Reduced rates throughout development support continue abscisic acid oxidation thereby increasing the release of gibberellins throughout plant development. A lower rate for an extended period is believed to mimic the value of a high rate for a reduced duration. As the plant grows, the root systems provide a wicking effect, aiding in the distribution of the external ROS. The absence of hydrogen peroxide may result in lower performance, lower feed value, and lower quality of overall development of the plant product. In some aspects of the present disclosure, the ROS may be applied at a first concentration during a soaking period. The soaking period may last for 10 minutes or 15 minutes. A lower rate for an extended soaking period may have the value of a high rate for a reduced duration. For example, the seed may be exposed to 200/300 ppm of ROS for a duration of 10 minutes during the soaking period. After the soaking period, the application of ROS may switch to a maintenance rate which may be 50-200 ppm throughout development.

During the application processes, the ROS may be applied by liquid applicator 46 as a liquid concentration. The application may include flood irrigation, drip irrigation, spray irrigation, subirrigation, or any other irrigation method that allows the ROS to reach the seed or the plant. The liquid applicator 46 may apply the ROS at a set time frame or at a quantifiable amount. For example, the liquid applicator 46 may apply the ROS for a first time period, such as 1 minute, and then the liquid applicator 46 may stop applying the ROS for a second time period, such as 4 minutes, or 1 min of ROS application for every 5 minutes. The cycle may continue until the developmental phase or seed out phase terminates. In another example, the ROS may be applied for 1 min every 2 hours. The liquid applicator 46 may provide a controlled, evenly distributed flow allowing the ROS to reach a maximum number of seeds. Excess ROS may be captured, recycled, and reused by the external ROS application system 10. If the growing surface 18 has an egress or a slant, the slant may aid in the even distribution of the ROS as it egresses through the holding container. In some aspects, the liquid applicator 46 may guide the distribution of the ROS to areas within the holding container, a portion of the seeds, or a portion of the plants that need more application. The liquid applicators 46 may also oscillate to cover the larger areas of the growing surface 18 or the entire length and width of the growing surface 18 or seed bed.

ROS may be applied separately from other liquids that are being supplied to the growing system. The ROS may be mixed with another liquid, such as water, an alkaline solution, or fertilizer, prior to distribution by the liquid applicator 46. The liquid applicator may have a plurality of nozzles for liquid distribution, each responsible for distributing one or more type of liquid. For example, a ROS nozzle and water nozzle may be converging nozzles and the ROS and water may be discharged simultaneously onto the substrate.

In another aspect of the application of ROS to increase dry matter, the plurality of seeds may be placed on a growing surface (Step 400). Next, a first reactive oxygen species of a plurality of reactive oxygen species may be introduced by a liquid applicator on to the growing surface at a first concentration for a first time period (Step 402). Next, the plurality of seeds may be disinfected by the first reactive oxygen species of a plurality of reactive oxygen species introduced by the liquid applicator (Step 404). In some aspects of the present disclosure, the seeds may be disinfected after being placed on the growing surface. Next, the plurality of seeds may germinate on the growing surface (Step 406). Next, a second reactive oxygen species of a plurality of reactive oxygen species may be discharged by the liquid applicator at a second concentration for a second time period (Step 408). In some aspects, different concentrations of ROS may be used during different stages of plant development or if it is determined that the plant or seed needs additional ROS to increase dry matter. Lastly, the plant may mature and be ready to be harvested (Step 410).

The disclosure is not to be limited to the particular aspects described herein. In particular, the disclosure contemplates numerous variations in increasing enzyme activity and dry matter using ROS in a hydroponic growing system. The foregoing description has been presented for purposes of illustration and description. It is not intended to be an exhaustive list or limit any of the disclosure to the precise forms disclosed. It is contemplated that other alternatives or exemplary aspects are considered included in the disclosure. The description is merely examples of aspects, processes or methods of the disclosure. It is understood that any other modifications, substitutions, and/or additions can be made, which are within the intended spirit and scope of the disclosure.

What is claimed is:

1. A method for external application of reactive oxygen species to increase dry matter and enzyme activity, the method comprising:
disinfecting a plurality of seeds with at least one reactive oxygen species, wherein the reactive oxygen species is configured to kill at least one of harmful bacteria, mold, or fungi;
externally applying the at least one reactive oxygen species to the plurality of seeds on a growing surface at a first concentration during a seed out phase, wherein the at least one reactive oxygen species increases gibberellic acid expression;
germinating the plurality of seeds; and
externally applying the at least one reactive oxygen species to the germinated plurality of seeds at a second concentration for a plant development phase until the germinated plurality of seeds mature.

2. The method of claim 1, wherein the at least one reactive oxygen species comprises hydrogen peroxide.

3. The method of claim 1, wherein the first concentration is between 1000 ppm to 3000 ppm.

4. The method of claim 1, further comprising:
weakening of at least one seed coat of the plurality of seeds by the at least one reactive oxygen species during the seed out phase, wherein the step of weakening the seed coat allows water to penetrate the seed coat at a faster rate.

5. The method of claim 1, further comprising:
decreasing abscisic acid expression by external application of the at least one reactive oxygen species.

6. The method of claim 1, wherein the step of external application of the at least one reactive oxygen species during the seed out phase supports the release of hydrolytic enzymes from a plurality of cellular tissues of the plurality of seeds.

7. The method of claim 1, wherein the step of external application of the at least one reactive oxygen species during the seed out phase promotes delignification pathways.

8. A external reactive oxygen species application system for increasing plant dry matter, the system comprising:
a growing surface operably supported by a framework and disposed across a length and width of the framework, wherein the growing surface is configured to house a plurality of seeds;
a reactive oxygen species source operably connected to the framework and configured to house at least one reactive oxygen species; and
one or more liquid applicators operably secured to the framework adjacent the growing surface for discharging the at least one reactive oxygen species from the reactive oxygen species source onto the plurality of seeds housed on the growing surface, wherein the one or more liquid applicators is configured to discharge the at least one reactive oxygen species at different concentrations;
wherein the at least one reactive oxygen species promotes germination of the plurality of seeds on the growing surface.

9. The external reactive oxygen species application system of claim 8, wherein the growing surface includes a top surface for hydroponically growing the plurality of seeds atop of the growing surface.

10. The external reactive oxygen species application system of claim 8, wherein the liquid applicator comprises a plurality of liquid distributors configured to evenly distribute the at least one reactive oxygen species evenly along the width of the growing surface and the length of the growing surface.

11. The external reactive oxygen species application system of claim 8, wherein the at least one reactive oxygen species is combined with water prior to being discharged from the liquid applicator.

12. The external reactive oxygen species application system of claim 8, wherein the liquid applicator discharges the at least one reactive oxygen species at a first concentration for a first time period and at a second concentration for a second time period.

13. The external reactive oxygen species application system of claim 8, wherein the liquid applicator is configured to discharge the at least one reactive oxygen species for a first period of time and wherein the liquid applicator is configured to stop discharging the at least one reactive species for a second period of time.

14. The external reactive oxygen species application system of claim 8, further comprising:
a seed cleaner operably connected to the framework, wherein the seed cleaner is configured to remove debris from the plurality of seeds prior to placing the plurality of seeds on the growing surface.

15. A method for increasing the dry matter of a plurality of plants by external application of reactive oxygen species, the method comprising:
placing a plurality of seeds on a growing surface, wherein the growing surface includes a top surface for hydroponically growing the plurality of seeds atop of the growing surface;
introducing the at least one reactive oxygen species by a liquid applicator on to the growing surface at a first concentration for a first time period;
disinfecting the plurality of seeds by a first reactive oxygen species of a plurality of reactive oxygen species introduced by the liquid applicator;
germinating the plurality of seeds on the growing surface; and
discharging a second reactive oxygen species of a plurality of reactive oxygen species by the liquid applicator at a second concentration for a second time period.

16. The method of claim 15, wherein first reactive oxygen species comprises at least one of hydrogen peroxide, hydroxyl radicals, hypochlorous acid, nitric acid, peroxyl radical, alkylperoxyl, hydroperoxyl, peroxynitrite anion, oxygen, superoxide anion, or peroxide.

17. The method of claim 15, wherein the second reactive oxygen species comprises at least one of hydrogen peroxide, hydroxyl radicals, hypochlorous acid, nitric acid, peroxyl radical, alkylperoxyl, hydroperoxyl, peroxynitrite anion, oxygen, superoxide anion, or peroxide.

18. The method of claim 15 wherein the first concentration ranges from 200 ppm to 3000 ppm.

19. The method of claim 15, wherein the second concentration ranges from 50 ppm to 200 ppm.

20. The method of claim 15, wherein the first time period ranges from 18 hours to 24 hours.
